(19) United States
(12) Patent Application Publication
(10) Pub. No.: US 2024/0395189 A1
(43) Pub. Date: Nov. 28, 2024

(54) DISPLAY PANEL AND DISPLAY DEVICE

(71) Applicant: Wuhan Tianma Micro-Electronics Co., Ltd., Wuhan (CN)

(72) Inventor: Wenshuai ZHANG, Wuhan (CN)

(21) Appl. No.: 18/235,660

(22) Filed: Aug. 18, 2023

(30) Foreign Application Priority Data
May 25, 2023 (CN) 202310603482.9

(51) Int. Cl. G09G 3/32

(52) U.S. Cl. CPC G09G 3/32; G09G 2300/0814; G09G 2310/0275; G09G 2320/0247

(57) ABSTRACT

A display panel and a display device are provided. The display panel includes a plurality of pixel circuit columns. A pixel circuit column of the plurality of pixel circuit columns includes a plurality of pixel circuits and is electrically connected with two data lines. One or both of the two data lines transmits a data signal and a bias signal to a pixel circuit of the plurality of pixel circuits in the pixel circuit column in a time-sharing manner.

### CROSS-REFERENCE TO RELATED APPLICATION

This application claims the priority of Chinese patent application No. 202310603482.9, filed on May 25, 2023, the entirety of which is incorporated herein by reference.

### FIELD

The present disclosure generally relates to the field of display technology and, more particularly, relates to a display panel and a display device.

### BACKGROUND

With the continuous advancement of display panel technology, users have increasingly higher demands for display quality. Among the related technologies, a pixel circuit can be combined with an on-state bias stress (OBS) circuit module to add a bias signal for periodically resetting the source or drain of a driving transistor, thereby improving the hysteresis phenomenon that may occur in the driving transistor during long-term operation, reducing flickering, and enhancing image quality.

However, because the bias signal needs to be additionally provided, there are certain challenges in implementing high-frequency driving for the display panel.

### SUMMARY

One aspect of the present disclosure provides a display panel. The display panel includes a plurality of pixel circuit columns. A pixel circuit column of the plurality of pixel circuit columns includes a plurality of pixel circuits and is electrically connected with two data lines. One or both of the two data lines transmits a data signal and a bias signal to a pixel circuit of the plurality of pixel circuits in the pixel circuit column in a time-sharing manner.

Another aspect of the present disclosure provides a display device. The display device includes a display panel. The display panel includes a plurality of pixel circuit columns. A pixel circuit column of the plurality of pixel circuit columns includes a plurality of pixel circuits and is electrically connected with two data lines. One or both of the two data lines transmits a data signal and a bias signal to a pixel circuit of the plurality of pixel circuits in the pixel circuit column in a time-sharing manner.

Other aspects of the present disclosure can be understood by those skilled in the art in light of the description, the claims, and the drawings of the present disclosure.

### BRIEF DESCRIPTION OF THE DRAWINGS

To more clearly illustrate the embodiments of the present disclosure, the drawings will be briefly described below. The drawings in the following description are certain embodiments of the present disclosure, and other drawings may be obtained by a person of ordinary skill in the art in view of the drawings provided without creative efforts.

FIG. 1 illustrates a schematic diagram of an exemplary display panel consistent with disclosed embodiments of the present disclosure;

FIG. 2 illustrates a schematic connection diagram of data lines in an exemplary display panel consistent with disclosed embodiments of the present disclosure;

FIG. 3 illustrates a schematic diagram of a pixel circuit of an exemplary display panel consistent with disclosed embodiments of the present disclosure;

FIG. 4 illustrates an exemplary timing sequence diagram of a display panel consistent with disclosed embodiments of the present disclosure;

FIG. 5 illustrates another exemplary timing sequence diagram of a display panel consistent with disclosed embodiments of the present disclosure;

FIG. 6 illustrates a schematic diagram of a pixel circuit of another exemplary display panel consistent with disclosed embodiments of the present disclosure;

FIG. 7 illustrates another exemplary timing sequence diagram of a display panel consistent with disclosed embodiments of the present disclosure;

FIG. 8 illustrates a schematic connection diagram of data lines in another exemplary display panel consistent with disclosed embodiments of the present disclosure;

FIG. 9 illustrates another exemplary timing sequence diagram of a display panel consistent with disclosed embodiments of the present disclosure;

FIG. 10 illustrates another exemplary timing sequence diagram of a display panel consistent with disclosed embodiments of the present disclosure;

FIG. 11 illustrates a schematic diagram of a pixel circuit of another exemplary display panel consistent with disclosed embodiments of the present disclosure;

FIG. 12 illustrates another exemplary timing sequence diagram of a display panel consistent with disclosed embodiments of the present disclosure;

FIG. 13 illustrates another exemplary timing sequence diagram of a display panel consistent with disclosed embodiments of the present disclosure;

FIG. 14 illustrates another exemplary timing sequence diagram of a display panel consistent with disclosed embodiments of the present disclosure;

FIG. 15 illustrates another exemplary timing sequence diagram of a display panel consistent with disclosed embodiments of the present disclosure;

FIG. 16 illustrates another exemplary timing sequence diagram of a display panel consistent with disclosed embodiments of the present disclosure; and

FIG. 17 illustrates a schematic diagram of an exemplary display device consistent with disclosed embodiments of the present disclosure.

### DETAILED DESCRIPTION OF THE DISCLOSURE

Reference will now be made in detail to exemplary embodiments of the disclosure, which are illustrated in the accompanying drawings. Wherever possible, the same reference numbers will be used throughout the drawings to refer to the same or the alike parts. The described embodiments are some but not all of the embodiments of the present disclosure. Based on the disclosed embodiments, persons of ordinary skill in the art may derive other embodiments consistent with the present disclosure, all of which are within the scope of the present disclosure.

It should be noted that the relational terms such as “first” and “second” are merely used to distinguish one entity or operation from another entity or operation, and do not necessarily require or imply any such actual relationship or sequence between these entities or operations. Moreover, the terms “include”, “contain” or any variant may be intended to cover non-exclusive inclusion, such that a process, a method, an article, or a device that includes a series of elements may not only include such elements, but also include any other element that is not clearly listed, or may include elements inherent to such process, method, article or device. In a case without more restrictions, the element defined by the sentence “including . . . ” may not exclude the existence of any other same element in the process, method, article, or device that includes the element.

It should be understood that when describing the structure of a component, when a layer or a region is referred to as being “on” or “above” another layer or another region, the layer or the region may be directly on the other layer or the other region, or other layers or regions may be contained between the layer or the region and the another layer or the another region. Further, when a component is turned over, the layer or the region may be “under” or “below” the another layer or the another region.

In addition, the term “and/or” may merely describe an association relationship of associated objects, which may include three kinds of relationships. For example, the term “A and/or B” may include three cases where A exists alone, A and B simultaneously exist, and B exists alone. In addition, the character “/” may often indicate that the associated objects before and after the character are in an “or” relationship.

In the present disclosure, the term “electrical connection” may refer to a direct electrical connection between two components, or may refer to an electrical connection between two components through one or more other components.

Various modifications and changes can be made to the embodiments of the present disclosure without departing from the spirit or scope of the present disclosure, which is apparent to those skilled in the art. Therefore, the present disclosure is intended to cover modifications and changes falling within the scope of the corresponding claims (the technical solutions to be protected) and their equivalents. It should be noted that the embodiments provided by the present disclosure can be combined with each other without contradiction.

Similar reference numbers and letters represent similar terms in the following Figures, such that once an item is defined in one Figure, it does not need to be further discussed in subsequent Figures.

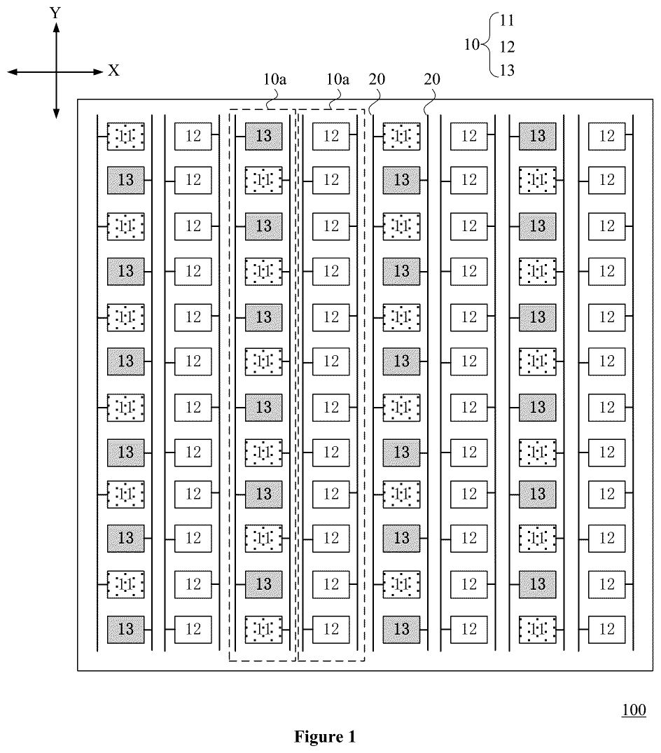

The present disclosure provides a display panel and a display device, to achieve high-frequency driving. FIG. 1 illustrates a schematic diagram of a display panel consistent with disclosed embodiments of the present disclosure. Referring to FIG. 1, the display panel 100 may include a plurality of pixel circuit columns 10a arranged in a row direction (X). Each pixel circuit column 10a may include a plurality of pixel circuits 10 arranged in a column direction (Y). Each pixel circuit column 10a may be electrically connected with two data lines 20. One data line 20 may transmit a data signal and a bias signal to the pixel circuit 10 in the pixel circuit column 10a in a time-sharing manner.

In one embodiment, one pixel circuit column 10a may be electrically connected with two data lines 20, which may be referred to as a double data line (DDL) design. Each data line 20 may transmit the data signal and the bias signal to the pixel circuit 10 in the pixel circuit column 10a in a time-sharing manner.

The pixel circuit 10 may be connected with a light-emitting element. The pixel circuit 10 may generate a driving current based on the data signal to drive the light-emitting element to emit light. The driving current generated by the pixel circuit 10 may vary depending on the data signal, which may lead to different brightness levels of the emitted light.

The bias signal “DVH signal” may be transmitted to the source or drain of the driving transistor of the pixel circuit 10, to reset the source or drain of the driving transistor, thereby improving the hysteresis phenomenon that may occur in the driving transistor during long-term operation.

In one embodiment, one pixel circuit column may be connected to two data lines, and one data line may transmit the data signal and the bias signal in a time-sharing manner. Therefore, one data line may not only transmit the data signal, but also alternately transmit the bias signal. In view of this, the high-frequency transmission of the signal may be implemented, which may facilitate to achieve the high-frequency driving of the display panel.

In one embodiment, the pixel circuit 10 may include a first pixel circuit 11, a second pixel circuit 12 and a third pixel circuit 13. The first pixel circuit 11 may be configured to drive a light-emitting element that emits red light, the second pixel circuit 12 may be configured to drive a light-emitting element that emits green light, and the third pixel circuit 13 may be configured to drive a light-emitting element that emits blue light.

In one embodiment, among two adjacent pixel circuit columns 10a, one pixel circuit column 10a may include the first pixel circuits 11 and the third pixel circuits 13 that are alternately arranged in the column direction (Y), and the other pixel circuit column 10a may include a plurality of second pixel circuits 12 arranged in the column direction (Y).

It should be noted that the arrangement of the pixel circuits shown in FIG. 1 may merely be an example, which may not intend to limit the present disclosure.

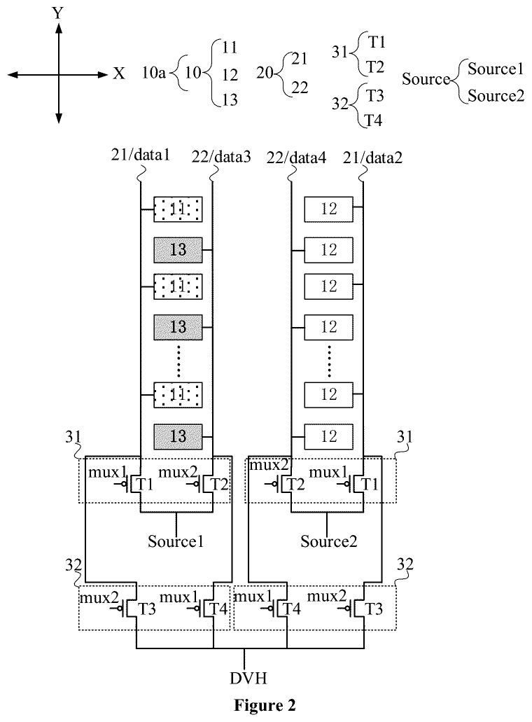

In one embodiment, as shown in FIG. 2, adjacent pixel circuit columns 10a may be connected to different data signal terminals “Source” via the data lines 20. The data signal terminal “Source” may be configured to provide a data signal.

In one embodiment, in the adjacent two pixel circuit columns 10a, one pixel circuit column 10a may be connected to a first data signal terminal “Source1” through the data line 20, and the other pixel circuit column 10a may be connected to a second data signal terminal “Source2” through the data line 20.

In one embodiment, by electrically connecting different pixel circuit columns 10a to different data signal terminals “Source”, the data signal may be accurately transmitted to the pixel circuit.

FIG. 2 may merely illustrate an example where the two data lines electrically connected to one pixel circuit column 10a may be connected to one data signal terminal. In certain embodiments, the two data lines electrically connected to one pixel circuit column 10a may be connected to different data signal terminals, which may be described in subsequent embodiments.

In certain embodiments, as shown in FIG. 2, the two data lines 20 connected to the pixel circuit column 10a may include a first data line 21 and a second data line 22.

The data signal may be configured to make the pixel circuit generate a driving current, and the bias signal may be configured to adjust a bias state of the driving transistor in the pixel circuit. The data signal and the bias signal may belong to different signal types. The different signal types may be understood that the functions of the data signal and the bias signal may be different. Both the data signal and the bias signal may be voltage signals. The voltage values of the data signal and the bias signal may be set to be the same or different depending on the specific situations.

In a same time period, the first data line 21 and the second data line 22 connected to the same one pixel circuit column 10a may transmit signals with different types. The first data lines 21 connected to adjacent two pixel circuit columns 10a may transmit signals with the same type, and the second data lines 22 connected to adjacent two pixel circuit columns 10a may transmit signals with the same type.

For illustrative purposes, as shown in FIG. 2, in adjacent two pixel circuit columns 10a, the first data line 21 connected to the first pixel circuit column 10a may be labeled as “data1”, the second data line 22 connected to the first pixel circuit column 10a may be labeled as “data3”, the first data line 21 connected to the second pixel circuit column 10a may be labeled as “data2”, and the second data line 22 connected to the second pixel circuit column 10a may be labeled as “data4”.

For example, in the same time period, the data line “data1” and the data line “data2” may be configured to transmit the data signal, and the data line “data3” and the data line “data4” may be configured to transmit the bias signal. Similarly, in another time period, the data line “data1” and the data line “data2” may be configured to transmit the bias signal, and the data line “data3” and the data line “data4” may be configured to transmit the data signal.

In one embodiment, in the same time period, the data line “data1” and the data line “data3” electrically connected with the same pixel circuit column may transmit signals with different types, and the data line “data2” and the data line “data4” electrically connected with the same pixel circuit column may transmit signals with different types. For example, while the data line “data1” transmits the data signal, the data line “data3” may transmit the bias signal. Alternatively, while the data line “data1” transmits the bias signal, the data line “data3” may transmit the data signal. In view of this, the frequency of the signal transmission may be improved, which may achieve the high-frequency driving of the two types of data signals. Additionally, in the same time period, the data line “data1” and the data line “data2” may transmit signals with the same type, and the data line “data3” and the data line “data4” may transmit signals with the same type. In view of this, the time division may not be substantially accurate, which may facilitate to achieve high-frequency driving.

In certain embodiments, the data line may be connected to either the data signal terminal or the bias signal terminal through a selection circuit. As shown in FIG. 2, the display panel may further include a first selection circuit 31 and a second selection circuit 32. The two data lines 20 connected to the same pixel circuit column 10a may be connected to the data signal terminal “Source” through the first selection circuit 31, and the two data lines 20 connected to the same pixel circuit column 10a may be connected to the bias signal terminal “DVH” through the second selection circuit 32. The first selection circuit 31 may be configured to transmit the data signal provided by the data signal terminal “Source” to the data line 20 in a time-sharing manner, and the second selection circuit 32 may be configured to transmit the bias signal provided by the bias signal terminal “DVH” to the data line 20 in a time-sharing manner.

In one embodiment, by controlling the turn-on or turn-off of the first selection circuit 31 and the second selection circuit 32, the data signal and the bias signal may be controlled to be sequentially written to the data line at specific times, enabling the data signal and the bias signal to alternately change.

In one embodiment, the first selection circuit 31 may be set to one-to-one correspond to the pixel circuit column 10a, and the second selection circuit 32 may be set to one-to-one correspond to the pixel circuit column 10a. For example, in adjacent two pixel circuit columns 10a, the data lines “data1” and “data3” connected to one pixel circuit column 10a may be connected to the first data signal terminal “Source1” through the first selection circuit 31, and the same data lines “data1” and “data3” may be connected to the bias signal terminal “DVH” through the second selection circuit 32. Similarly, the data lines “data2” and “data4” connected to the other pixel circuit column 10a may be connected to the second data signal terminal “Source2” through the first selection circuit 31, and the same data lines “data2” and “data4” may be connected to the bias signal terminal “DVH” through the second selection circuit 32.

In a case where each pixel circuit may require the same bias signal, all data lines may be electrically connected to a same bias signal terminal “DVH”.

In certain embodiments, as shown in FIG. 2, the two data lines 20 connected to the pixel circuit column 10a may include the first data line 21 and the second data line 22.

The first selection circuit 31 and the second selection circuit 32 each may include two switches. The first selection circuit 31 may include a first switch T1 and a second switch T2. Both a first terminal of the first switch T1 and a first terminal of the second switch T2 may be connected to the data signal terminal “Source”, a second terminal of the first switch T1 may be connected to the first data line 21, and a second terminal of the second switch T2 may be connected to the second data line 22. The second selection circuit 32 may include a third switch T3 and a fourth switch T4. Both a first terminal of the third switch T3 and a first terminal of the fourth switch T4 may be connected to the bias signal terminal “DVH”, a second terminal of the third switch T3 may be connected to the first data line 21, and a second terminal of the fourth switch T4 may be connected to the second data line 22.

The first switch T1 and the fourth switch T4 may be simultaneously turned on or off under the control of a first control signal line “mux1”, and the second switch T2 and the third switch T3 may be simultaneously turned on or off under the control of a second control signal line “mux2”. The first switch T1 and the second switch T2 may be sequentially turned on or off under the control of the first control signal line and the second control signal line, respectively.

In one embodiment, the first switch T1, the second switch T2, the third switch T3, and the fourth switch T4 may be transistors.

When the control signal on the first control signal line “mux1” is in a turned-on level, the first switch T1 and the fourth switch T4 may be turned on, allowing the data signal of the data signal terminal “Source” to be transmitted to the first data line 21, and the bias signal of the bias signal terminal “DVH” to be transmitted to the second data line 22. Similarly, when the control signal on the second control signal line “mux2” is in the turned-on level, the data signal of the data signal terminal “Source” may be transmitted to the second data line 22, and the bias signal of the bias signal terminal “DVH” may be transmitted to the first data line 21. In view of this, each data line may be capable of transmitting the data signal and the bias signal in a time-sharing manner.

It should be understood that the signal on the first control signal line “mux1” and the signal on the second control signal line “mux2” may be sequentially in the turned-on level.

In certain embodiments, the pixel circuit may be connected to either the first data line or the second data line. Referring to FIG. 2, pixel circuits in odd-numbered rows of the pixel circuit column 10a may be connected to the first data line 21, and pixel circuits in even-numbered rows of the pixel circuit column 10a may be connected to the second data line 22.

In one embodiment, taking the column where the first pixel circuit 11 and the third pixel circuit 13 are located as an example, the first pixel circuit 11 may be in an odd-numbered row, and the third pixel circuit 13 may be in an even-numbered row. The first pixel circuit 11 may be connected to the first data line 21, and the third pixel circuit 13 may be connected to the second data line 22.

In one embodiment, the pixel circuit in the odd-numbered row and the pixel circuit in the even-numbered row may be connected to different data lines, which may facilitate to avoid signal interference between different rows and to ensure the accuracy of signal transmission.

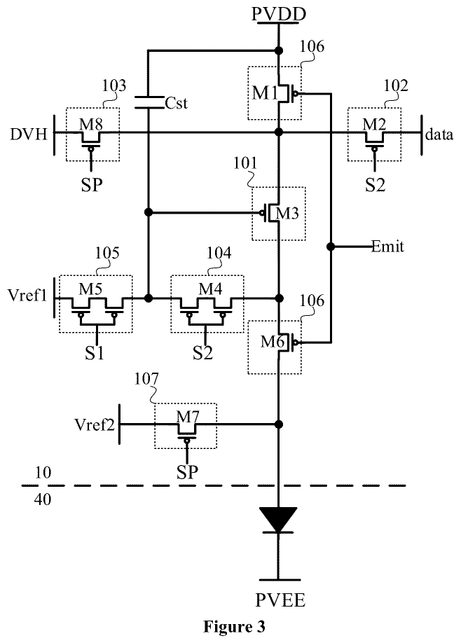

In certain embodiments, when the pixel circuit is connected to one of the first data line and the second data line, different functional modules may be used to transmit the data signal and the bias signal. As shown in FIG. 3, the pixel circuit 10 may include a driving module 101, a data-writing module 102, and a bias module 103. The data-writing module 102 may be configured to transmit the data signal to the driving module 101, and the bias module 103 may be configured to transmit the bias signal to the driving module 101.

Referring to FIG. 2 and FIG. 3, when the pixel circuit is connected to one of the first data line and the second data line, both the data-writing module 102 and the bias module 103 of pixel circuit 10 in the odd-numbered row in the pixel circuit column 10a may be connected to the first data line 21, and both the data-writing module 102 and the bias module 103 of the pixel circuit 10 in the even-numbered row in the pixel circuit column 10a may be connected to the second data line 22.

In one embodiment, on the basis of providing the selection circuits, the data-writing module 102 may provide the data signal to the driving module 101, and the bias module 103 may provide the bias signal to the driving module 101, which may facilitate to avoid interference between different signals. Furthermore, the data-writing module 102 and the bias module 103 of the same pixel circuit may be connected to the same data line, which may facilitate efficient utilization of the data line.

In one embodiment, the data signal terminal “Source” may be configured to provide the data signal, and the bias signal terminal “DVH” may be configured to provide the bias signal. The data-writing module 102 and the bias module 103 of the pixel circuit 10 may be electrically connected to the data signal terminal “Source” and the bias signal terminal “DVH” through the same data line. It should be understood that the data line may be connected to the data signal terminal “Source” through the first selection circuit and to the bias signal terminal “DVH” through the second selection circuit.

In one embodiment, the data-writing module 102 may be turned on or off under the control of a scan line S2, and the bias module may be turned on or off under the control of a scan line SP. In the various embodiments of the present disclosure, the turned-on level may be a low level as an example.

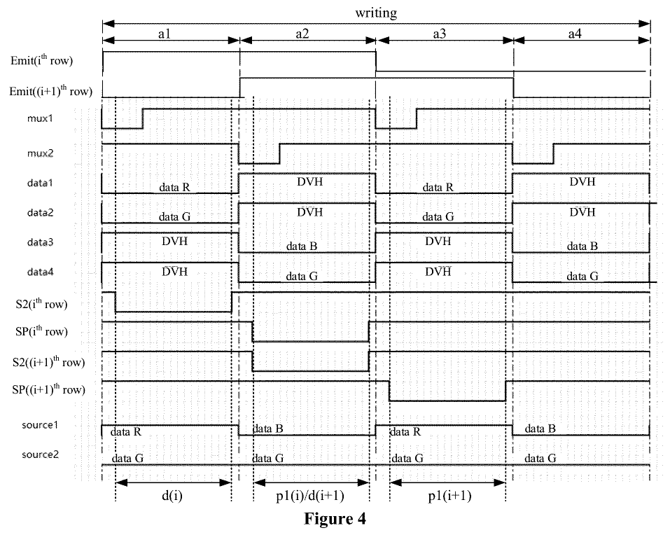

In certain embodiments, on the basis of providing the selection circuits, the pixel circuit may be connected to one of the first data line and the second data line, and the pixel circuit may include the data-writing module 102 and the bias module 103. As shown in FIG. 4, within a time period of displaying one frame, the working process of the pixel circuit may include a data-writing stage (writing), and the data-writing stage (writing) may include a data-writing sub-stage and a first bias sub-stage.

To distinguish sub-stages of pixel circuits in different rows, as shown in FIG. 4, the data-writing sub-stage d(i) and the first bias sub-stage p1(i) may correspond to the pixel circuit in the i^{th} row, and the data-writing sub-stage d(i+1) and the first bias sub-stage p1(i+1) may correspond to the pixel circuit in the (i+1)^{th} row, where i may be an integer greater than 0.

In the data-writing sub-stage, the data-writing module 102 of the pixel circuit 10 may be turned on, and the data signal on the data line may be written into the driving module 101.

In the first bias sub-stage, the bias module 103 of the pixel circuit 10 may be turned on, and the bias signal on the data line may be written into the driving module 101.

In the data-writing stage (writing), the control signals on the first control signal line “mux1” and the second control signal line “mux2” may be sequentially in the turned-on level.

In one embodiment, as shown in FIG. 4, for the pixel circuits in a same row, the first bias sub-stage p1(i) may occur after the data-writing sub-stage d(i). For example, for the pixel circuit in the i^{th} row, the first bias sub-stage p1(i) may occur after the data-writing sub-stage d(i). For the pixel circuit in the (i+1)^{th} row, the first bias sub-stage p1(i+1) may occur after the data-writing sub-stage d(i+1).

The first bias sub-stage p1(i) of the pixel circuit in the i^{th} row and the data-writing sub-stage d(i+1) of the pixel circuit in the (i+1)^{th} row may at least partially overlap in time.

Referring to FIGS. 2-4, for adjacent two rows of pixel circuits, the variation process of the control signals on the first control signal line “mux1” and the second control signal line “mux2” may include stages a1-a4, and the working process of the display panel may include following.

First, during at least part of stage a1, the signal on the first control signal line “mux1” may be in a turned-on level. In view of this, the first switch T1 and the fourth switch T4 may be simultaneously turned on. The data signal “data R” for the pixel circuit in the i^{th} row provided by the first data signal terminal “Source1” may be transmitted to the data line “data1” through the first switch T1, and the data signal “data G” for the pixel circuit in the i^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the data-writing sub-stage d(i), the scan line S2 connected to the pixel circuit in the i^{th} row may be in a turned-on level, and the data-writing module 102 of the pixel circuit in the i^{th} row may be turned on. The data signal “data R” on the data line “data1” may be written into the driving module 101 of the first pixel circuit 11 in the i^{th} row, and the data signal “data G” on the data line “data2” may be written into the driving module 101 of the second pixel circuit 12 in the i^{th} row.

During at least part of stage a2, the signal on the second control signal line “mux2” may be in a turned-on level. In view of this, the second switch T2 and the third switch T3 may be simultaneously turned on. The data signal “data B” for the pixel circuit in the (i+1)^{th} row provided by the first data signal terminal “Source1” may be transmitted to the data line “data3” through the second switch T2, and the data signal “data G” for the pixel circuit in the (i+1)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the first bias sub-stage p1(i), the scan line SP connected to the pixel circuit in the i^{th} row may be in a turned-on level, and the bias module 103 of the pixel circuit in the i^{th} row may be turned on. The bias signal on the data line “data1” may be written into the driving module 101 of the first pixel circuit 11 in the i^{th} row, and the bias signal on the data line “data2” may be written into the driving module 101 of the second pixel circuit 12 in the i^{th} row.

The data-writing sub-stage d(i+1) may overlap with the first bias sub-stage p1(i).

In the data-writing sub-stage d(i+1), the scan line S2 connected to the pixel circuit in the (i+1)^{th} row may be in a turned-on level, and the data-writing module 102 of the pixel circuit in the (i+1)^{th} row may be turned on. The data signal “data B” on the data line “data3” may be written into the driving module 101 of the third pixel circuit 13 in the (i+1)^{th} row, and the data signal “data G” on the data line “data4” may be written into the driving module 101 of the second pixel circuit 12 in the (i+1)^{th} row.

During at least part of stage a3, the signal on the first control signal line “mux1” may be in a turned-on level. In view of this, the first switch T1 and the fourth switch T4 may be simultaneously turned on. The data signal “data R” for the pixel circuit in the (i+2)^{th} row provided by the first data signal terminal “Source1” may be transmitted to the data line “data1” through the first switch T1, and the data signal “data G” for the pixel circuit in the (i+2)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the first bias sub-stage p1(i+1), the scan line SP connected to the pixel circuit in the (i+1)^{th} row may be in a turned-on level, and the bias module 103 of the pixel circuit in the (i+1)^{th} row may be turned on. The bias signal on the data line “data3” may be written into the driving module 101 of the first pixel circuit 11 in the (i+1)^{th} row, and the bias signal on the data line “data4” may be written into the driving module 101 of the second pixel circuit 12 in the (i+1)^{th} row. The rest may be deduced by analogy.

FIG. 4 may merely illustrate the timing sequence of two rows of pixel circuits. It should be understood that the first bias sub-stage p1(i+1) of the pixel circuit in the (i+1)^{th} row and the data-writing sub-stage d(i+2) of the pixel circuit in the (i+2)^{th} row may overlap at least partially in time, where in one embodiment, i may take a value of 1.

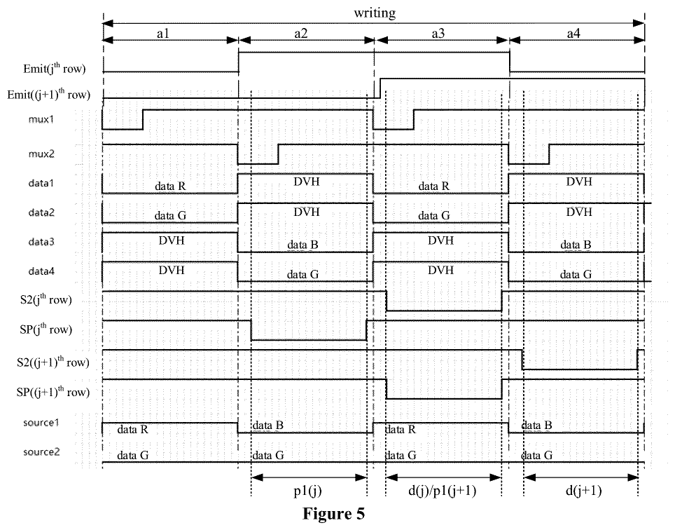

In another embodiment, as shown in FIG. 5, for the pixel circuits in the same row, the first bias sub-stage may occur before the data-writing sub-stage. For example, for the pixel circuit in the j^{th} row, the first bias sub-stage p1(j) may occur before the data-writing sub-stage do). For the pixel circuit in the (i+i)^{th} row, the first bias sub-stage p1(j+1) may occur before the data-writing sub-stage d(j+1), where j may be an integer greater than 0.

The data-writing sub-stage d(j) of the pixel circuit in the j^{th} row and the first bias sub-stage p1(j+1) of the pixel circuit in the (j+1)^{th} row may overlap at least partially in time.

Referring to FIG. 2, FIG. 3, and FIG. 5, the working process of the display panel may include following.

First, during at least part of stage a1, the signal on the first control signal line “mux1” may be in a turned-on level. In view of this, the first switch T1 and the fourth switch T4 may be simultaneously turned on. The data signal “data R” for the pixel circuit in the j^{th} row provided by the first data signal terminal “Source1” may be transmitted to the data line “data1” through the first switch T1, and the data signal “data G” for the pixel circuit in the j^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

In view of this, the scan lines S2 and SP connected to the pixel circuit in the j^{th} row, as well as the scan lines S2 and SP connected to the pixel circuit in the (j+1)^{th} row may be in a turned-off level, such that the signals on the data lines may not be written into the pixel circuit in the j^{th} row and the pixel circuit in the (j+1)^{th} row.

During at least part of stage a2, the signal on the second control signal line “mux2” may be in a turned-on level. In view of this, the second switch T2 and the third switch T3 may be simultaneously turned on. The data signal “data B” for the pixel circuit in the (j+1)^{th} row provided by the first data signal terminal “Source1” may be transmitted to the data line “data3” through the second switch T2, and the data signal “data G” for the pixel circuit in the j+1)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the first bias sub-stage p1(j), the scan line SP connected to the pixel circuit in the j^{th} row may be in a turned-on level, and the bias module 103 of the pixel circuit in the j^{th} row may be turned on. The bias signal on the data line “data1” may be written into the driving module 101 of the first pixel circuit 11 in the i^{th} row, and the bias signal on the data line “data2” may be written into the driving module 101 of the second pixel circuit 12 in the i^{th} row.

During at least part of stage a3, the signal on the first control signal line “mux1” may be in a turned-on level. In view of this, the first switch T1 and the fourth switch T4 may be simultaneously turned on. The data signal “data R” for the pixel circuit in the (j+2)^{th} row provided by the first data signal terminal “Source1” may be transmitted to the data line “data1” through the first switch T1, and the data signal “data G” for the pixel circuit in the (j+2)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the data-writing sub-stage d(i), the scan line S2 connected to the pixel circuit in the j^{th} row may be in a turned-on level, and the data-writing module 102 of the pixel circuit in the j^{th} row may be turned on. The data signal “data R” on the data line “data1” may be written into the driving module 101 of the first pixel circuit 11 in the j^{th} row, and the data signal “data G” on the data line “data2” may be written into the driving module 101 of the second pixel circuit 12 in the j^{th} row.

The first bias sub-stage p1(+1) may overlap with the data-writing sub-stage d(i).

During the first bias sub-stage p1(j+1), the scan line SP connected to the pixel circuit in the (j+1)^{th} row may be in a turned-on level, and the bias module 103 of the pixel circuit in the (j+1)^{th} row may be turned on. The bias signal on the data line “data3” may be written into the driving module 101 of the first pixel circuit 11 in the (j+1)^{th} row, and the bias signal on the data line “data4” may be written into the driving module 101 of the second pixel circuit 12 in the (j+1)^{th} row.

During at least part of stage a4, the signal on the second control signal line “mux2” may be in a turned-on level. In view of this, the second switch T2 and the third switch T3 may be simultaneously turned on. The data signal “data B” for the pixel circuit in the (j+3)^{th} row provided by the first data signal terminal “Source1” may be transmitted to the data line “data3” through the second switch T2, and the data signal “data G” for the pixel circuit in the (j+3)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

During the data-writing sub-stage d(j+1), the scan line S2 connected to the pixel circuit in the (j+1)^{th} row may be in a turned-on level, and the data-writing module 102 of the pixel circuit in the (j+1)^{th} row may be turned on. The data signal “data R” on the data line “data3” may be written into the driving module 101 of the third pixel circuit 13 in the (j+1)^{th} row, and the data signal “data G” on the data line “data4” may be written into the driving module 101 of the second pixel circuit 12 in the (j+1)^{th} row. The rest may be deduced by analogy. In one embodiment, j may be taken a value of 1.

FIG. 5 may merely illustrate the timing sequence of two rows of pixel circuits. It should be understood that the first bias sub-stage p1(j+2) of the pixel circuit in the (j+2)^{th} row and the data-writing sub-stage d(j+1) of the pixel circuit in the (j+1)^{th} row may overlap at least partially in time.

In the embodiments associated with FIG. 4 or FIG. 5, in the adjacent two rows of pixel circuits, by allowing the data-writing sub-stage of one row of pixel circuits to at least partially overlap with the first bias sub-stage of another row of pixel circuits, the data signal and the bias signal may be transmitted to the driving module through the same data line.

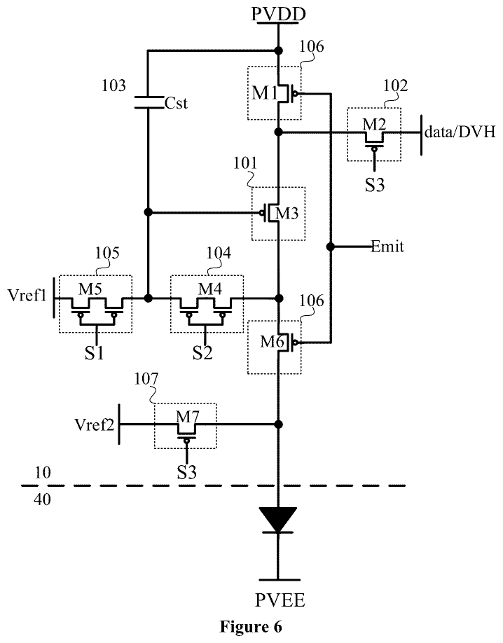

In certain embodiments, in a case where the selection circuits are provided, a same functional module may be used to transmit the data signal and the bias signal in a time-sharing manner. As shown in FIG. 6, the pixel circuit 10 may include the driving module 101 and the data-writing module 102. The data-writing module 102 may be used to transmit the data signal and the bias signal to the driving module 101 in a time-sharing manner. The difference between the embodiment associated with FIG. 6 and the embodiment associated with FIG. 3 may include that the pixel circuit shown in FIG. 6 may not require an additional functional module for transmitting the bias signal.

Referring to FIG. 2 and FIG. 6, when the pixel circuit is connected to one of the first data line and the second data line, the data-writing module 102 of the pixel circuit 10 in the odd-numbered row in the pixel circuit column 10a may be connected to the first data line 21, and the data-writing module 102 of the pixel circuit 10 in the even-numbered row in the pixel circuit column 101a may be connected to the second data line 22.

In the present disclosure, in a case where the selection circuits are provided, the data-writing module 102 may be used to transmit the data signal and the bias signal to the driving module 101 in a time-sharing manner, to reduce the number of functional modules in the pixel circuit, which may facilitate to improve the resolution of the display panel.

In one embodiment, the data signal terminal “Source” may be configured to provide the data signal, and the bias signal terminal “DVH” may be configured to provide the bias signal. The data-writing module 102 in the pixel circuit 10 may be electrically connected to both the data signal terminal “Source” and the bias signal terminal “DVH” through a same data line. It should be understood that the data line may be connected to the data signal terminal “Source” through the first selection circuit, and may be connected to the bias signal terminal “DVH” through the second selection circuit.

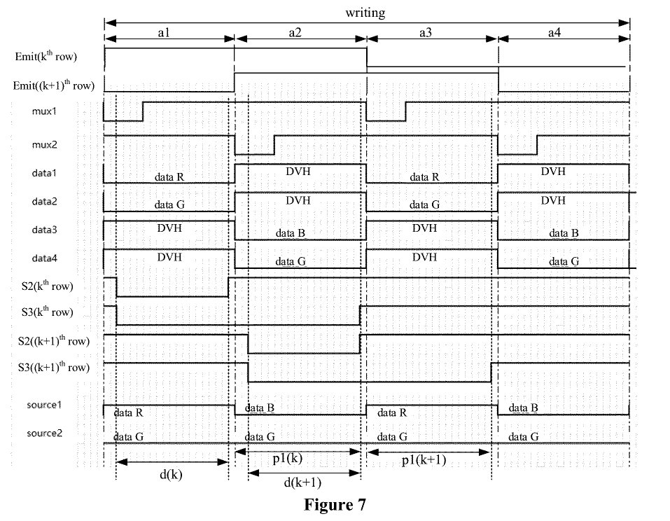

In certain embodiments, in a case where the selection circuits are provided and the data-writing module 102 of the pixel circuit is used to transmit the data signal and the bias signal in a time-sharing manner, referring to FIG. 7, during a time period of displaying one frame, the working process of the pixel circuit may include a data-writing stage (writing), and the data-writing stage (writing) may include a data-writing sub-stage and a first bias sub-stage. To distinguish sub-stages of pixel circuits in different rows, as shown in FIG. 7, the data-writing sub-stage d(k) and the first bias sub-stage p1(k) may correspond to the pixel circuit in the k^{th} row, and the data-writing sub-stage d(k+1) and the first bias sub-stage p1(k+1) may correspond to the pixel circuit in the (k+1)^{th} row, where k may be an integer greater than 0.

In the data-writing sub-stage, the driving module 101 of the pixel circuit may be written with the data signal. In the first bias sub-stage, the driving module 101 of the pixel circuit may be written with the bias signal.

In one embodiment, the pixel circuit may further include a threshold compensation module 104. The threshold compensation module 104 may be turned on or off under the control of the scan line S2, and the data-writing module 102 may be turned on or off under the control of the scan line S3.

In the data-writing sub-stage, both the data-writing module 102 and the threshold compensation module 104 of the pixel circuit may be turned on, and the data signal may be written into the control terminal of the driving module 101. In the first bias sub-stage, the threshold compensation module 104 may be turned off, the data-writing module 102 may be turned on, and the bias signal may be written into the source or drain of the driving transistor M3 of the driving module 101.

In the data-writing stage (writing), the control signals on the first control signal line “mux1” and the second control signal line “mux2” may be sequentially in a turned-on level.

In one embodiment, as shown in FIG. 7, for the pixel circuits in a same row, the first bias sub-stage may occur after the data-writing sub-stage. For example, for the pixel circuit in the k^{th} row, the first bias sub-stage p1(k) may occur after the data-writing sub-stage d(k). For the pixel circuit in the (k+1)^{th} row, the first bias sub-stage p1(k+1) may occur after the data-writing sub-stage d(k+1).

The first bias sub-stage p1(k) of the pixel circuit in the k^{th} row may at least partially overlap with the data-writing sub-stage d(k+1) of the pixel circuit in the (k+1)^{th} row in time.

Referring to FIG. 2, FIG. 6 and FIG. 7, the working process of the display panel may include following.

First, during at least part of stage a1, the signal on the first control signal line “mux1” may be in a turned-on level. In view of this, the first switch T1 and the fourth switch T4 may be simultaneously turned on. The data signal “data R” for the pixel circuit in the k^{th} row provided by the first data signal terminal “Source1” may be transmitted to the data line “data1” through the first switch T1, and the data signal “data G” for the pixel circuit in the k^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the data-writing sub-stage d(k), the scan lines S2 and S3 connected to the pixel circuit in the k^{th} row may be in a turned-on level, and the data-writing module 102 and the threshold compensation module 104 of the pixel circuit in the k^{th} row may be turned on. The data signal “data R” on the data line “data1” may be written into the control terminal of the driving module 101 of the first pixel circuit 11 in the k^{th} row, and the data signal “data G” on the data line “data2” may be written into the control terminal of the driving module 101 of the second pixel circuit 12 in the k^{th} row.

During at least part of stage a2, the signal on the second control signal line “mux2” may be in a turned-on level. In view of this, the second switch T2 and the third switch T3 may be simultaneously turned on. The data signal “data B” for the pixel circuit in the (k+1)^{th} row provided by the first data signal terminal “Source1” may be transmitted to the data line “data3” through the second switch T2, and the data signal “data G” for the pixel circuit in the (k+1)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the first bias sub-stage p1(k), the scan line S3 connected to the pixel circuit in the k^{th} row may be in a turned-on level, and the data-writing module 102 of the pixel circuit in the k^{th} row may be turned on. The bias signal on the data line “data1” may be written into the driving module 101 of the first pixel circuit 11 in the k^{th} row, and the bias signal on the data line “data2” may be written into the driving module 101 of the second pixel circuit 12 in the k^{th} row.

The data-writing sub-stage d(k+1) may overlap with the first bias sub-stage p1(k).

In the data-writing sub-stage d(k+1), the scan lines S2 and S3 connected to the pixel circuit in the (k+1)^{th} row may be in a turned-on level, and the data-writing module 102 and the threshold compensation module 104 of the pixel circuit in the (k+1)^{th} row may be turned on. The data signal “data B” on the data line “data3” may be written into the control terminal of the driving module 101 of the third pixel circuit 13 in the (k+1)^{th} row, and the data signal “data G” on the data line “data4” may be written into the control terminal of the driving module 101 of the second pixel circuit 12 in the (k+1)^{th} row.

During at least part of stage a3, the signal on the first control signal line “mux1” may be in a turned-on level. In view of this, the first switch T1 and the fourth switch T4 may be simultaneously turned on. The data signal “data R” for the pixel circuit in the (k+2)^{th} row provided by the first data signal terminal “Source1” may be transmitted to the data line “data1” through the first switch T1, and the data signal “data G” for the pixel circuit in the (k+2)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the first bias sub-stage p1(k+1), the scan line S3 connected to the pixel circuit in the (k+1)^{th} row may be in a turned-on level, and the data-writing module 102 of the pixel circuit in the (k+1)^{th} row may be turned on. The bias signal on the data line “data1” may be written into the driving module 101 of the first pixel circuit 11 in the (k+1)^{th} row, and the bias signal on the data line “data2” may be written into the driving module 101 of the second pixel circuit 12 in the (k+1)^{th} row. The rest may be deduced by analogy.

FIG. 7 may merely illustrate the timing sequence of two rows of pixel circuits. It should be understood that the first bias sub-stage p1(k+1) of the pixel circuit in the (k+1)^{th} row and the data-writing sub-stage d(k+2) of the pixel circuit in the (k+2)^{th} row may overlap at least partially in time, where in one embodiment, k may take a value of 1.

In certain embodiments, the two data lines electrically connected to the pixel circuit column may include the first data line and the second data line. The pixel circuit may be connected to both the first data line and the second data line.

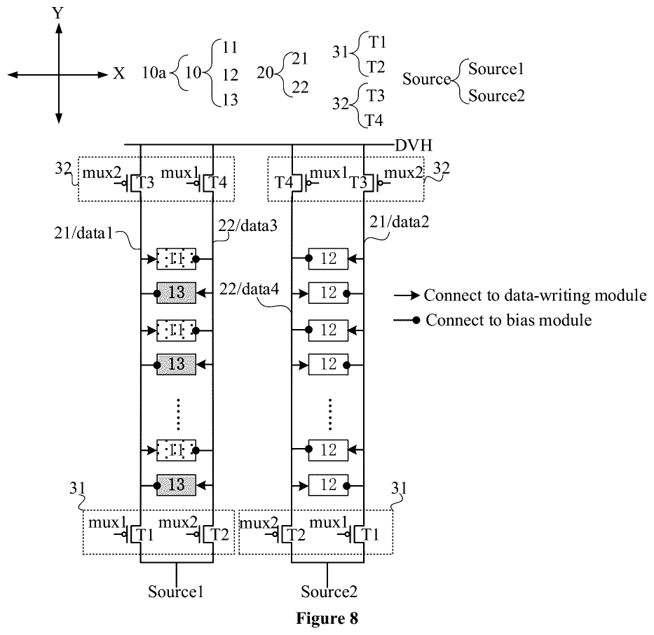

Referring to FIG. 8, each pixel circuit in the pixel circuit column 10a may be electrically connected to both the first data line 21 and the second data line 22.

In one embodiment, one pixel circuit may be connected to different data lines, which may facilitate to transmit the data signal and the bias signal to the pixel circuit separately using different data lines, may avoid interference between signals received by the same pixel circuit, and may improve the accuracy of signal transmission.

In certain embodiments, when the pixel circuit is connected to both the first data line and the second data line, different functional modules may be used to transmit the data signal and the bias signal, respectively. As shown in FIG. 3, the pixel circuit 10 may include the driving module 101, the data-writing module 102, and the bias module 103. The data-writing module 102 may be configured to transmit the data signal to the driving module 101, and the bias module 103 may be configured to transmit the bias signal to the driving module 101.

Referring to FIG. 8 and FIG. 3, the data-writing module 102 of the pixel circuit 10 in the odd-numbered row in the pixel circuit column 10a may be connected to the first data line 21, and the bias module 103 of the pixel circuit 10 in the odd-numbered row in the pixel circuit column 10a may be connected to the second data line 22. The data-writing module 102 of the pixel circuit 10 in the even-numbered row in the pixel circuit column 10a may be connected to the second data line 22, and the bias module 103 of the pixel circuit 10 in the even-numbered row in the pixel circuit column 10a may be connected to the first data line 21.

In one embodiment, the data-writing module 102 may be configured to provide the data signal to the driving module 101, and the bias module 103 may be configured to provide the bias signal to the driving module 101, which may facilitate to avoid crosstalk between different signals. Additionally, the data-writing module 102 and the bias module 103 of the same pixel circuit may be connected to different data lines, which may further facilitate to prevent crosstalk between the data signal and the bias signal that are transmitted to the same pixel circuit.

To distinguish the connections between the data-writing module as well as the bias module and the two data lines in the same pixel circuit, as shown in FIG. 8, the connection line with an arrow may represent the connection between the data line and the data-writing module 102 of the pixel circuit, and the connection line with solid dots may represent the connection between the data line and the bias module 103 of the pixel circuit.

For example, taking the column where the first pixel circuit 11 and the third pixel circuit 13 are located as an example, the first pixel circuit 11 may be in an odd-numbered row, and the third pixel circuit 13 may be in an even-numbered row. The data-writing module 102 of the first pixel circuit 11 may be connected to the first data line 21/data1, and the bias module 103 of the first pixel circuit 11 may be connected to the second data line 22/data3. The data-writing module 102 of the third pixel circuit 13 may be connected to the second data line 22/data3, and the bias module 103 of the third pixel circuit 13 may be connected to the first data line 21/data1.

Similarly, taking the column where the second pixel circuit 12 is located as an example, the data-writing module 102 of the second pixel circuit 12 in the odd-numbered row may be connected to the first data line 21/data2, and the bias module 103 of the second pixel circuit 12 in the odd-numbered row may be connected to the second data line 22/data4. The data-writing module 102 of the second pixel circuit 12 in the even-numbered row may be connected to the second data line 22/data4, and the bias module 103 of the second pixel circuit 12 in the even-numbered row may be connected to the first data line 21/data2.

In one embodiment, the data signal terminal “Source” may be configured to provide the data signal, and the bias signal terminal “DVH” may be configured to provide the bias signal. Each data line may be electrically connected to both the data signal terminal “Source” and the bias signal terminal “DVH”. It should be understood that the data line may be connected to the data signal terminal “Source” through the first selection circuit, and may be connected to the bias signal terminal “DVH” through the second selection circuit.

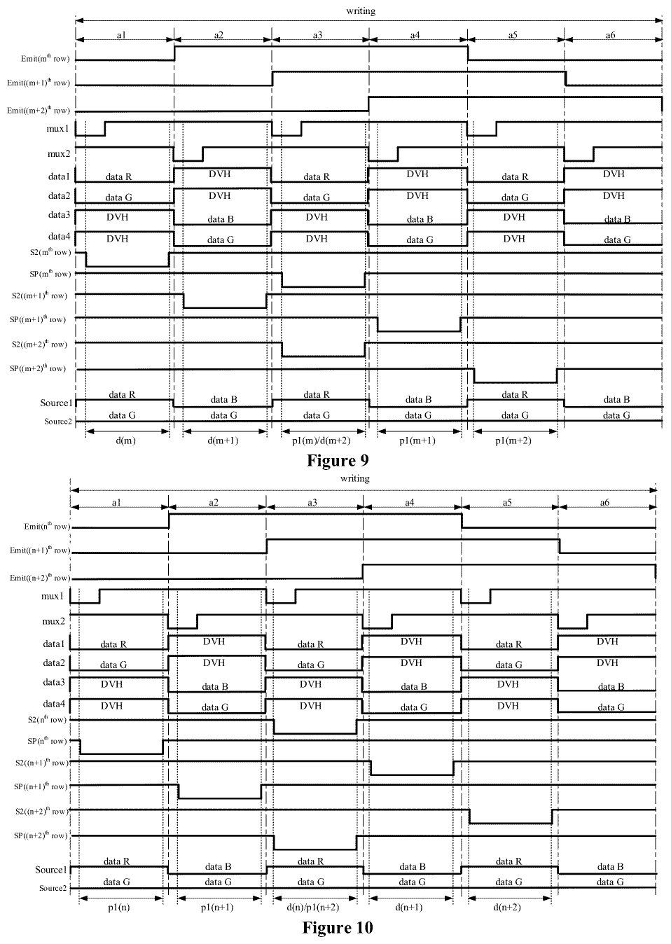

In certain embodiments, when the pixel circuit is connected to both the first data line and the second data line, and the pixel circuit includes the data-writing module 102 and the bias module 103, as shown in FIG. 9, during a time period of displaying one frame, the working process of the pixel circuit may include the data-writing stage (writing), and the data-writing stage (writing) may include a data-writing sub-stage and a first bias sub-stage.

To distinguish sub-stages of pixel circuits in different rows, as shown in FIG. 9, the data-writing sub-stage d(m) and the first bias sub-stage p1(m) may correspond to the pixel circuit in the m^{th} row, the data-writing sub-stage d(m+1) and the first bias sub-stage p1(m+1) may correspond to the pixel circuit in the (m+1)^{th} row, and the data-writing sub-stage d(m+2) and the first bias sub-stage p1(m+2) may correspond to the pixel circuit in the (m+2)^{th} row, where i may be an integer greater than 0.

In the data-writing sub-stage, the data-writing module 102 of the pixel circuit 10 may be turned on, and the data signal on the data line may be written into the driving module 101.

In the first bias sub-stage, the bias module 103 of the pixel circuit 10 may be turned on, and the bias signal on the data line may be written into the driving module 101.

In the data-writing stage (writing), the control signals on the first control signal line “mux1” and the second control signal line “mux2” may be sequentially in the turned-on level.

In one embodiment, as shown in FIG. 9, for the pixel circuits in a same row, the first bias sub-stage may occur after the data-writing sub-stage. For example, for the pixel circuit in the m^{th} row, the first bias sub-stage p1(m) may occur after the data-writing sub-stage d(m). For the pixel circuit in the (m+1)^{th} row, the first bias sub-stage p1(m+1) may occur after the data-writing sub-stage d(m+1). For the pixel circuit in the (m+2)^{th} row, the first bias sub-stage p1(m+2) may occur after the data-writing sub-stage d(m+2).

The first bias sub-stage of the pixel circuit in the m^{th} row and the data-writing sub-stage of the pixel circuit in the (m+2)^{th} row may at least partially overlap in time.

Referring to FIG. 8, FIG. 3 and FIG. 9, for adjacent three rows of pixel circuits, the variation process of the control signals on the first control signal line “mux1” and the second control signal line “mux2” may include stages a1-a6, and the working process of the display panel may include following.

First, during at least part of stage a1, the signal on the first control signal line “mux1” may be in a turned-on level. In view of this, the first switch T1 and the fourth switch T4 may be simultaneously turned on. The data signal “data R” for the pixel circuit in the m^{th} row provided by the first data signal terminal “Source1” may be transmitted to the data line “data1” through the first switch T1, and the data signal “data G” for the pixel circuit in the m^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the data-writing sub-stage d(m), the scan line S2 connected to the pixel circuit in the m^{th} row may be in a turned-on level, and the data-writing module 102 of the pixel circuit in the m^{th} row may be turned on. The data signal “data R” on the data line “data1” may be written into the driving module 101 of the first pixel circuit 11 in the m^{th} row, and the data signal “data G” on the data line “data2” may be written into the driving module 101 of the second pixel circuit 12 in the m^{th} row.

During at least part of stage a2, the signal on the second control signal line “mux2” may be in a turned-on level. In view of this, the second switch T2 and the third switch T3 may be simultaneously turned on. The data signal “data B” for the pixel circuit in the (m+1)^{th} row provided by the first data signal terminal “Source1” may be transmitted to the data line “data3” through the second switch T2, and the data signal “data G” for the pixel circuit in the (m+1)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the data-writing sub-stage d(m+1), the scan line S2 connected to the pixel circuit in the (m+1)^{th} row may be in a turned-on level, and the data-writing module 102 of the pixel circuit in the (m+1)^{th} row may be turned on. The data signal “data B” on the data line “data3” may be written into the driving module 101 of the third pixel circuit 13 in the (m+1)^{th} row, and the data signal “data G” on the data line “data4” may be written into the driving module 101 of the second pixel circuit 12 in the (m+1)^{th} row.

During at least part of stage a3, the signal on the first control signal line “mux1” may be in a turned-on level. In view of this, the first switch T1 and the fourth switch T4 may be simultaneously turned on. The data signal “data R” for the pixel circuit in the (m+2)^{th} row provided by the first data signal terminal “Source1” may be transmitted to the data line “data1” through the first switch T1, and the data signal “data G” for the pixel circuit in the (m+2)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

In the data-writing sub-stage d(m+2), the scan line S2 connected to the pixel circuit in the (m+2)^{th} row may be in a turned-on level, and the data-writing module 102 of the pixel circuit in the (m+2)^{th} row may be turned on. The data signal “data R” on the data line “data1” may be written into the driving module 101 of the first pixel circuit 11 in the (m+2)^{th} row, and the data signal “data G” on the data line “data2” may be written into the driving module 101 of the second pixel circuit 12 in the (m+2)^{th} row.

The data-writing sub-stage d(m+2) may overlap with the first bias sub-stage p1(m).

In the first bias sub-stage p1(m), the scan line SP connected to the pixel circuit in the m^{th} row may be in a turned-on level, and the bias module 103 of the pixel circuit in the m^{th} row may be turned on. The bias signal on the data line “data3” may be written into the driving module 101 of the first pixel circuit 11 in the m^{th} row, and the bias signal on the data line “data4” may be written into the driving module 101 of the second pixel circuit 12 in the m^{th} row.

During at least part of stage a4, the signal on the second control signal line “mux2” may be in a turned-on level. In view of this, the second switch T2 and the third switch T3 may be simultaneously turned on. The data signal “data B” for the pixel circuit in the (m+3)^{th} row provided by the first data signal terminal “Source1” may be transmitted to the data line “data3” through the second switch T2, and the data signal “data G” for the pixel circuit in the (m+3)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the first bias sub-stage p1(m+1), the scan line SP connected to the pixel circuit in the (m+1)^{th} row may be in a turned-on level, and the bias module 103 of the pixel circuit in the (m+1)^{th} row may be turned on. The bias signal on the data line “data1” may be written into the driving module 101 of the third pixel circuit 13 in the (m+1)^{th} row, and the bias signal on the data line “data2” may be written into the driving module 101 of the second pixel circuit 12 in the (m+1)^{th} row.

During at least part of stage a5, the signal on the first control signal line “mux1” may be in a turned-on level. In view of this, the first switch T1 and the fourth switch T4 may be simultaneously turned on. The data signal “data R” for the pixel circuit in the (m+4)^{th} row provided by the first data signal terminal “Source1” may be transmitted to the data line “data1” through the first switch T1, and the data signal “data G” for the pixel circuit in the (m+4)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the first bias sub-stage p1(m+2), the scan line Sp connected to the pixel circuit in the (m+2)^{th} row may be in a turned-on level, and the bias module 103 of the pixel circuit in the (m+2)^{th} row may be turned on. The bias signal on the data line “data3” may be written into the driving module 101 of the first pixel circuit 11 in the (m+2)^{th} row, and the bias signal on the data line “data4” may be written into the driving module 101 of the second pixel circuit 12 in the (m+2)^{th} row. The rest may be deduced by analogy. In one embodiment, m may take a value of 1.

FIG. 9 may merely illustrate the timing sequence of three rows of pixel circuits. It should be understood that the first bias sub-stage p1(m+1) of the pixel circuit in the (m+1)^{th} row and the data-writing sub-stage d(m+3) of the pixel circuit in the (m+3)^{th} row may overlap at least partially in time.

In another embodiment, as shown in FIG. 10, for the pixel circuits in the same row, the first bias sub-stage may occur before the data-writing sub-stage. For example, for the pixel circuit in the n^{th} row, the first bias sub-stage p1(n) may occur before the data-writing sub-stage d(n). For the pixel circuit in the (n+1)^{th} row, the first bias sub-stage p1(n+1) may occur before the data-writing sub-stage d(n+1). For the pixel circuit in the (n+2)^{th} row, the first bias sub-stage p1(n+2) may occur before the data-writing sub-stage d(n+2), where n may be an integer greater than 0.

The data-writing sub-stage of the pixel circuit in the n^{th} row and the first bias sub-stage of the pixel circuit in the (n+2)^{th} row may overlap at least partially in time.

Referring to FIG. 8, FIG. 3, and FIG. 10, the working process of the display panel may include following.

First, during at least part of stage a1, the signal on the first control signal line “mux1” may be in a turned-on level. In view of this, the first switch T1 and the fourth switch T4 may be simultaneously turned on. The data signal “data R” for the pixel circuit in the n^{th} row provided by the first data signal terminal “Source1” may be transmitted to the data line “data1” through the first switch T1, and the data signal “data G” for the pixel circuit in the n^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

In the first bias sub-stage p1(n), the scan line SP connected to the pixel circuit in the n^{th} row may be in a turned-on level, and the bias module 103 of the pixel circuit in the n^{th} row may be turned on. The bias signal on the data line “data3” may be written into the driving module 101 of the first pixel circuit 11 in the n^{th} row, and the bias signal on the data line “data4” may be written into the driving module 101 of the second pixel circuit 12 in the n^{th} row.

During at least part of stage a2, the signal on the second control signal line “mux2” may be in a turned-on level. In view of this, the second switch T2 and the third switch T3 may be simultaneously turned on. The data signal “data B” for the pixel circuit in the (n+1)^{th} row provided by the first data signal terminal “Source1” may be transmitted to the data line “data3” through the second switch T2, and the data signal “data G” for the pixel circuit in the (n+1)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

In the first bias sub-stage p1(n+1), the scan line SP connected to the pixel circuit in the (n+1)^{th} row may be in a turned-on level, and the bias module 103 of the pixel circuit in the (n+1)^{th} row may be turned on. The bias signal on the data line “data1” may be written into the driving module 101 of the third pixel circuit 13 in the (n+1)^{th} row, and the bias signal on the data line “data2” may be written into the driving module 101 of the second pixel circuit 12 in the (n+1)^{th} row.

During at least part of stage a3, the signal on the first control signal line “mux1” may be in a turned-on level. In view of this, the first switch T1 and the fourth switch T4 may be simultaneously turned on. The data signal “data R” for the pixel circuit in the (n+2)^{th} row provided by the first data signal terminal “Source1” may be transmitted to the data line “data1” through the first switch T1, and the data signal “data G” for the pixel circuit in the (n+2)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the first bias sub-stage p1(n+2), the scan line SP connected to the pixel circuit in the (n+2)^{th} row may be in a turned-on level, and the bias module 103 of the pixel circuit in the (n+2)^{th} row may be turned on. The bias signal on the data line “data3” may be written into the driving module 101 of the first pixel circuit 11 in the (n+2)^{th} row, and the bias signal on the data line “data4” may be written into the driving module 101 of the second pixel circuit 12 in the (n+2)^{th} row.

The data-writing sub-stage d(n) may overlap with the first bias sub-stage p1(n+2).

During the data-writing sub-stage d(n), the scan line S2 connected to the pixel circuit in the n^{th} row may be in a turned-on level, and the data-writing module 102 of the pixel circuit in the n^{th} row may be turned on. The data signal “data R” on the data line “data1” may be written into the driving module 101 of the first pixel circuit 11 in the n^{th} row, and the data signal “data G” on the data line “data2” may be written into the driving module 101 of the second pixel circuit 12 in the n^{th} row.

During at least part of stage a4, the signal on the second control signal line “mux2” may be in a turned-on level. In view of this, the second switch T2 and the third switch T3 may be simultaneously turned on. The data signal “data B” for the pixel circuit in the (n+3)^{th} row provided by the first data signal terminal “Source1” may be transmitted to the data line “data3” through the second switch T2, and the data signal “data G” for the pixel circuit in the (n+3)^{th} row provided by the second data signal terminal “Source2” may be transmitted to the data line “data4” through the second switch T2. The bias signal provided by the bias signal terminal “DVH” may be transmitted to the data lines “data1” and “data2” through the third switch T3, respectively.

During the data-writing sub-stage d(n+1), the scan line S2 connected to the pixel circuit in the (n+1)^{th} row may be in a turned-on level, and the data-writing module 102 of the pixel circuit in the (n+1)^{th} row may be turned on. The data signal “data R” on the data line “data3” may be written into the driving module 101 of the third pixel circuit 13 in the (n+1)^{th} row, and the data signal “data G” on the data line “data4” may be written into the driving module 101 of the second pixel circuit 12 in the (n+1)^{th} row.

During at least part of stage a5, the signal on the first control signal line “mux1” may be in a turned-on level. In view of this, the first switch T1 and the fourth switch T4 may be simultaneously turned on. The data signal “data R” for the pixel circuit in the (n+4)^{th} row provided by the first data signal terminal “Source1” may be transmitted to the data line “data1” through the first switch T1, and the data signal “data G” for the pixel circuit in the (n+4)^{th} row provided by the second data signal terminal “Source2” may be transmitted to the data line “data2” through the first switch T1. The bias signal provided by the bias signal terminal “DVH” may be transmitted to the data lines “data3” and “data4” through the fourth switch T4, respectively.

During the data-writing sub-stage d(n+2), the scan line S2 connected to the pixel circuit in the (n+2)^{th} row may be in a turned-on level, and the data-writing module 102 of the pixel circuit in the (n+2)^{th} row may be turned on. The data signal “data R” on the data line “data1” may be written into the driving module 101 of the first pixel circuit 11 in the (n+2)^{th} row, and the data signal “data G” on the data line “data2” may be written into the driving module 101 of the second pixel circuit 12 in the (n+2)^{th} row. The rest may be deduced by analogy. In one embodiment, n may be taken a value of 1.

FIG. 10 may merely illustrate the timing sequence of three rows of pixel circuits. It should be understood that the data-writing sub-stage d(n+1) of the pixel circuit in the (n+1)^{th} row and the first bias sub-stage p1(n+3) of the pixel circuit in the (n+3)^{th} row may overlap at least partially in time.

In the embodiments associated with FIG. 9 or FIG. 10, two data lines may be used to transmit the data signal and the bias signal to the driving module.

In certain embodiments, the data line may be connected to the data signal terminal without the selection circuits. As shown in FIG. 11, the two data lines 20 connected to the pixel circuit column 10a may include the first data line 21 and the second data line 22.

The pixel circuits in odd-numbered rows of the pixel circuit column 10a may be connected to the first data line 21, and the pixel circuits in even-numbered rows of the pixel circuit column 10a may be connected to the second data line 22.

The first data line 21 and the second data line 22 may be connected to different data signal terminals “Source”, and the data signal terminal may be configured to provide the data signal and the bias signal in a time-sharing manner.

In one embodiment, selection circuits may not be required, which may facilitate to achieve a narrow border. Additionally, the data signal terminal “Source” may be configured to provide the data signal and the bias signal in a time-sharing manner, which may reduce the number of signal ports on the driving chip, and may facilitate to lower the chip cost.

In one embodiment, in the adjacent two pixel circuit columns 10a, one pixel circuit column 10a may be connected to the first data signal terminal “Source1” through the first data line 21, and may be connected to the second data signal terminal “Source2” through the second data line 22. The other pixel circuit column 10a may be connected to the third data signal terminal “Source3” through the first data line 21, and may be connected to the fourth data signal terminal “Source4” through the second data line 22.

In certain embodiments, when the pixel circuit is connected to one of the first data line and the second data line, different functional modules may be used to transmit the data signal and the bias signal, respectively. As shown in FIG. 3, the pixel circuit 10 may include the driving module 101, the data-writing module 102, and the bias module 103. The data-writing module 102 may be configured to transmit the data signal to the driving module 101, and the bias module 103 may be configured to transmit the bias signal to the driving module 101.

Referring to FIG. 11 and FIG. 3, when the pixel circuit is connected to one of the first data line and the second data line, both the data-writing module 102 and the bias module 103 of pixel circuit 10 in the odd-numbered row in the pixel circuit column 10a may be connected to the first data line 21, and both the data-writing module 102 and the bias module 103 of the pixel circuit 10 in the even-numbered row in the pixel circuit column 10a may be connected to the second data line 22.

In one embodiment, in a case where the selection circuits are not required, the data-writing module 102 may provide the data signal to the driving module 101, and the bias module 103 may provide the bias signal to the driving module 101, which may facilitate to avoid crosstalk between different signals. Additionally, the data-writing module 102 and the bias module 103 of the same pixel circuit may be connected to the same data line, which may facilitate efficient utilization of the data line.

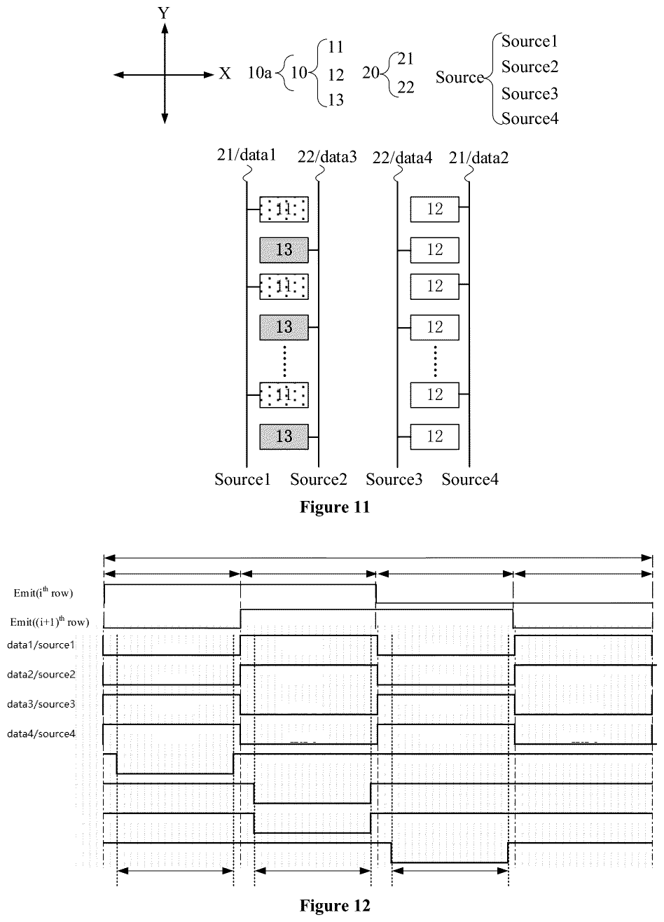

In certain embodiments, in a case where the selection circuits are not required, the pixel circuit is connected to one of the first data line and the second data line, and the pixel circuit includes the data-writing module 102 and the bias module 103, referring to FIG. 12, during a time period of displaying one frame, the working process of the pixel circuit may include the data-writing stage (writing), and the data-writing stage (writing) may include a data-writing sub-stage and a first bias sub-stage.

During the data-writing sub-stage, the data-writing module 102 of the pixel circuit 10 may be turned on, and the data signal on the data line may be written into the driving module 101.

During the first bias sub-stage, the bias module 103 of the pixel circuit 10 may be turned on, and the bias signal on the data line may be written into the driving module 101.

As an example, as shown in FIG. 12, for the pixel circuits in a same row, the first bias sub-stage may occur after the data-writing sub-stage.

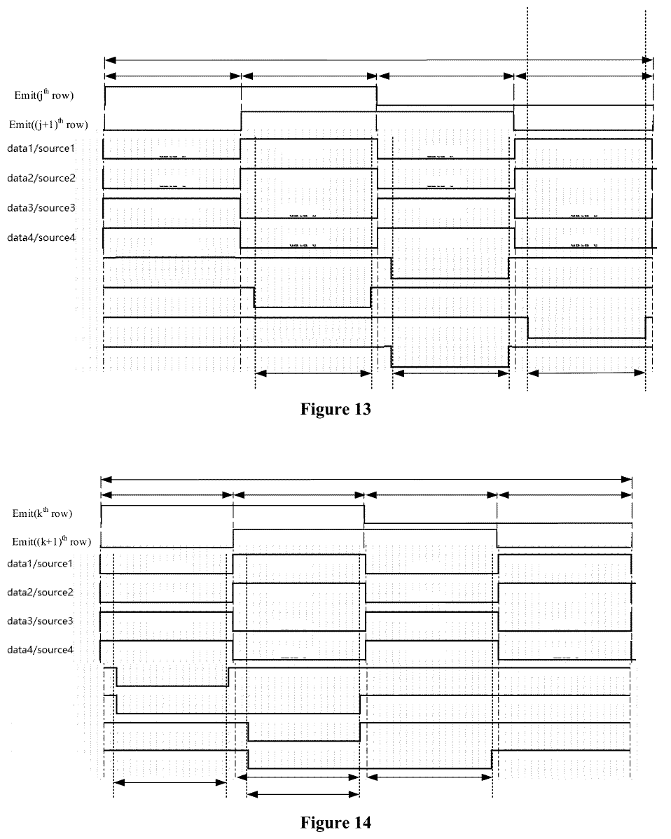

As another example, as shown in FIG. 13, for the pixel circuits in a same row, the first bias sub-stage may occur before the data-writing sub-stage.

The similarities between the embodiments associated with FIG. 12 and FIG. 4, as well as between the embodiments associated with FIG. 13 and FIG. 5, may not be repeated, and the difference may include that in the embodiments associated with FIG. 12 and FIG. 13, both the data signal and the bias signal may be provided by the data signal terminal.

In stage a1, the first data signal terminal “Source1” may provide the data signal “data R”, the second data signal terminal “Source2” may provide the data signal “data G”, and both the third data signal terminal “Source3” and the fourth data signal terminal “Source4” may provide the bias signal “DVH”.

In stage a2, both the first data signal terminal “Source1” and the second data signal terminal “Source2” may provide the bias signal “DVH”, the third data signal terminal “Source3” may provide the data signal “data B”, and the fourth data signal terminal “Source4” may provide the bias signal “DVH”.

In stage a3, the signals provided by the data signal terminals may be the same as the signals in stage a1.

In stage a4, the signals provided by the data signal terminals may be the same as the signals in stage a2.

In certain embodiments, in a case where the selection circuits are not required, a same functional module may be used to transmit the data signal and the bias signal in a time-sharing manner. As shown in FIG. 6, the pixel circuit 10 may include the driving module 101 and the data-writing module 102. The data-writing module 102 may be configured to transmit the data signal and the bias signal to the driving module 101 in a time-sharing manner.

Referring to FIG. 11 and FIG. 6, when the pixel circuit is connected to one of the first data line and the second data line, the data-writing module 102 of the pixel circuit 10 in the odd-numbered row in the pixel circuit column 10a may be connected to the first data line 21, and the data-writing module 102 of the pixel circuit 10 in the even-numbered row in the pixel circuit column 10a may be connected to the second data line 22.

In one embodiment, in a case where the selection circuits are not required, the data-writing module 102 may be configured to transmit the data signal and the bias signal to the driving module 101 in a time-sharing manner, which may reduce the number of functional modules in the pixel circuit, and may facilitate to improve the resolution of the display panel.

In certain embodiments, when the selection circuits are provided and the data-writing module 102 of the pixel circuit is used to transmit the data signal and the bias signal in a time-sharing manner, referring to FIG. 14, during a time period of displaying one frame, the working process of the pixel circuit may include the data-writing stage (writing), and the data-writing stage (writing) may include a data-writing sub-stage and a first bias sub-stage.

During the data-writing sub-stage, the driving module 101 of the pixel circuit may be written with the data signal, and during the first bias sub-stage, the driving module 101 of the pixel circuit may be written with the bias signal.

In one embodiment, the pixel circuit may further include a threshold compensation module 104. The threshold compensation module 104 may be turned on or off under the control of the scan line S2, and the data-writing module 102 may be turned on or off under the control of the scan line S3.

During the data-writing sub-stage, both the data-writing module 102 and the threshold compensation module 104 of the pixel circuit may be turned on, and the data signal may be written into the control terminal of the driving module 101. During the first bias sub-stage, the threshold compensation module 104 may be turned off, the data-writing module 102 may be turned on, and the bias signal may be written into the source or drain of the driving transistor M3 of the driving module 101.

In one embodiment, as shown in FIG. 14, for the pixel circuits in a same row, the first bias sub-stage may occur after the data-writing sub-stage. For example, for the pixel circuit in the k^{th} row, the first bias sub-stage p1(k) may occur after the data-writing sub-stage d(k). For the pixel circuit in the (k+1)^{th} row, the first bias sub-stage p1(k+1) may occur after the data-writing sub-stage d(k+1).

The first bias sub-stage p1(k) of the pixel circuit in the k^{th} row may at least partially overlap with the data-writing sub-stage d(k+1) of the pixel circuit in the (k+1)^{th} row in time.

The similarities between the embodiments associated with FIG. 14 and FIG. 7 may not be repeated, and the difference may include that in the embodiments associated with FIG. 14, both the data signal and the bias signal may be provided by the data signal terminal.

In stage a1, the first data signal terminal “Source1” may provide the data signal “data R”, the second data signal terminal “Source2” may provide the data signal “data G”, and both the third data signal terminal “Source3” and the fourth data signal terminal “Source4” may provide the bias signal “DVH”.

In stage a2, both the first data signal terminal “Source1” and the second data signal terminal “Source2” may provide the bias signal “DVH”, the third data signal terminal “Source3” may provide the data signal “data B”, and the fourth data signal terminal “Source4” may provide the bias signal “DVH”.

In stage a3, the signals provided by the data signal terminals may be the same as the signals in stage a1.

In stage a4, the signals provided by the data signal terminals may be the same as the signals in stage a2.

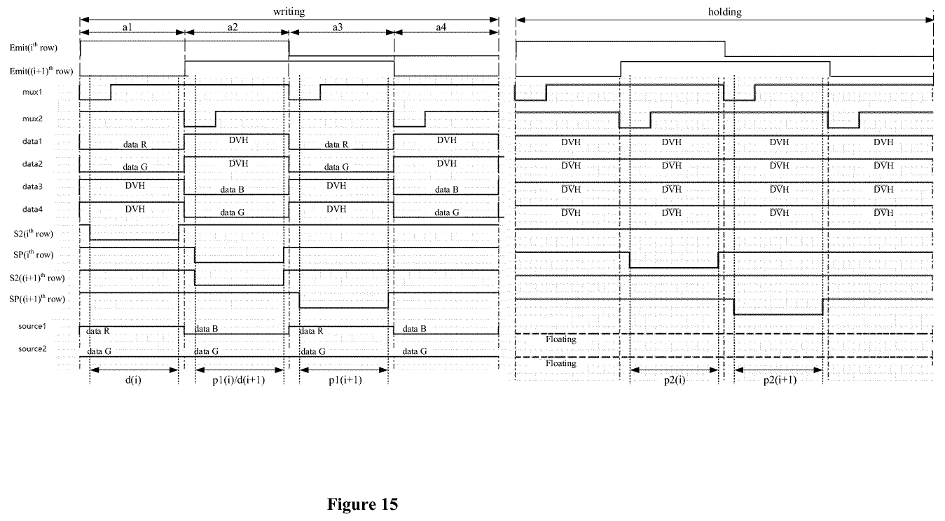

In certain embodiments, the disclosed display panel may support an operating mode with a low refresh rate. As shown in FIG. 15, the working process of the pixel circuit may further include a holding stage. During the data-writing stage (writing), the data signal may be written into the control terminal of the driving module; and during the holding stage, the data signal may no longer be written into the control terminal of the driving module. During the holding stage, the potential of the control terminal of the driving module may be maintained at the potential during the data-writing stage (writing).

The holding stage may include at least one second bias sub-stage. During the second bias sub-stage, the driving module 101 of the pixel circuit may be written with the bias signal, and the data signal terminal “Source” connected to the data line 20 may be in a floating state or may be used to provide the bias signal.

To distinguish the sub-stages of the pixel circuits in different rows, as shown in FIG. 15, the second bias sub-stage p2(i) may correspond to the pixel circuit in the i^{th} row, and the second bias sub-stage p2(i+1) may correspond to the pixel circuit in the (i+1)^{th} row.

In one embodiment, the bias signal may be maintained on the data line during the holding stage, which may facilitate to prevent short circuit.

For example, in a case where the display panel includes both the data signal terminal and the bias signal terminal, during the data-writing stage (writing), the data signal terminal may be configured to provide the data signal, and the bias signal terminal may be configured to provide the bias signal. During the holding stage, the data signal terminal may be in a floating state or may be used to provide the bias signal.

In another example, in a case where the data signal terminal of the display panel is used to provide the data signal and the bias signal in a time-sharing manner, during the data-writing stage (writing), the data signal terminal may provide the data signal and the bias signal in a time-sharing manner, and during the holding stage, the data signal terminal may continuously provide the bias signal.

It should be noted that for illustrative purposes, in FIG. 15, the display panel may include the selection circuit, the pixel circuit may include the data-writing module and the bias module, the scan line S2 may control the data writing module, the scan line SP may control the bias module, and the first bias sub-stage may occur after the data-writing sub-stage, which may not be limited by the present disclosure. It should be understood that when the display panel is not provided with the selection circuit, or the data-writing module of the pixel circuit transmits the data signal and the bias signal in a time-sharing manner, the working process of the pixel circuit may also include the holding stage (holding), and the holding stage (holding) may include at least one second bias sub-stage.

It should be noted that in the embodiments associated with FIG. 2 and FIG. 11, for illustrative purposes, the data line “data1” may be connected to the first pixel circuit 11, and the data line “data3” may be connected to the third pixel circuit 13, which may not be limited by the present disclosure. In certain embodiments, the data line “data1” may be connected to the third pixel circuit 13, and the data line “data3” may be connected to the first pixel circuit 11.

In the embodiments associated with FIG. 8, for illustrative purposes, the data line “data1” may be connected to the data-writing module of the first pixel circuit 11, the data line “data1” may be connected to the bias module of the third pixel circuit 13, the data line “data3” may be connected to the data-writing module of the third pixel circuit 13, the data line “data3” may be connected to the bias module of the first pixel circuit 11, which may not be limited by the present disclosure. In certain embodiments, the data line “data1” may be connected to the data-writing module of the third pixel circuit 13, the data line “data1” may be connected to the bias module of the first pixel circuit 11, the data line “data3” may be connected to the data-writing module of the first pixel circuit 11, the data line “data3” may be connected to the bias module of the third pixel circuit 13.

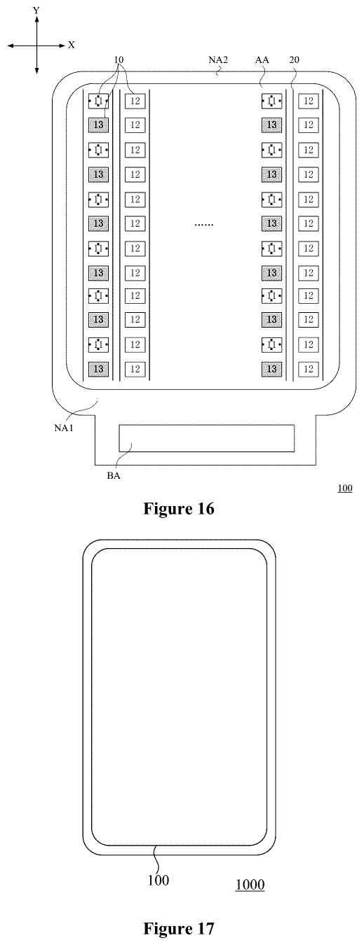

In one embodiment, as shown in FIG. 16, the display panel may include a display region (AA) and a non-display region at least partially surrounding the display region (AA). The non-display region may include a first non-display region (NA1) and a second non-display region (NA2) that are opposite to each other in the column direction (Y). The first non-display region (NA1) and the second non-display region (NA2) may be separated by the display region (AA). The first non-display region (NA1) may include a bonding region (BA), and the bonding region (BA) may be used to bond the driving chip.

As described above, the display panel may include the first selection circuit 31 and the second selection circuit 32.

In one embodiment, the first selection circuit 31 and the second selection circuit 32 may be located in the first non-display region (NA1).

In another embodiment, one of the first selection circuit 31 and the second selection circuit 32 may be located in the first non-display region (NA1), and the other one may be located in the second non-display region (NA2). For example, the first selection circuit 31 may be located in the first non-display region (NA1), and the second selection circuit 32 may be located in the second non-display region (NA2).

In one embodiment, as shown in FIG. 3 or FIG. 6, the pixel circuit 10 may be connected to a light-emitting element 40. The light-emitting element 40 may include an organic light-emitting diode (OLED).

In one embodiment, the pixel circuit 10 may further include a threshold compensation module 104, a first reset module 105, a light-emitting control module 106, a second reset module 107, and a storage capacitor Cst.

The light-emitting control module 106 may include a transistor M1 and a transistor M6, the data-writing module 102 may include a transistor M2, the driving module 101 may include a transistor M3, the threshold compensation module 104 may include a transistor M4, the first reset module 105 may include a transistor M5, and the second reset module 107 may include a transistor M7. In a case where the pixel circuit includes the bias module 103, the bias module 103 may include a transistor M8. In addition, in FIG. 7, “Vref1” may represent the first reset signal, “Vref2” may represent the second reset signal, “Emit” may represent the light-emitting control signal, “PVDD” may represent the positive power supply signal, and “PVEE” may represent the negative power supply signal. The first reset signal “Vref1” may be used to reset the gate of the driving transistor M3, and the second reset signal “Vref2” may be used to reset the anode of the light-emitting element 40. The light-emitting control signal “Emit” may be used to control the pixel circuit to enter the light-emitting stage. The connection relationships of the elements in the pixel circuit may refer to FIG. 3 or FIG. 6, and may not be repeated herein.

It should be noted that in the disclosed various timing sequence diagrams, the signal on the scan line S1 may not be illustrated. It should be understood that for the pixel circuits in the same row, the duration of the light-emitting control signal “Emit” at the cutoff level may cover the duration of the scan line S1 being in the turned-on level. For example, taking FIG. 3 as an example, the turned-on level of the scan line S1 may be before the turned-on level of the scan line S2. For the pixel circuits in the same row, during the data-writing stage, the duration of the light-emitting control signal “Emit” at the cutoff level may cover the duration of the scan line S1 being in the turned-on level, the duration of the scan line S2 being in the turned-on level, and the duration of the scan line SP being in the turned-on level.

The present disclosure also provides a display device. FIG. 17 illustrates a schematic diagram of a display device consistent with disclosed embodiments of the present disclosure. Referring to FIG. 7, the display device 1000 may include the display panel 100 provided in any of the above disclosed embodiments. The embodiment associated with FIG. 17 may merely use a mobile phone as an example to describe the display device 1000. It should be understood that the disclosed display device may include a wearable product, a computer, a television, a vehicle-mounted display device, or any other display device with a display function, which may not be limited by the present disclosure. The disclosed display device may have the beneficial effects of the disclosed display panel, which may refer to the descriptions of the disclosed display panel in the disclosed embodiments, and may not be repeated herein.

The disclosed display panel and display device may have following beneficial effects. In the disclosed display panel, one pixel circuit column may be connected to two data lines, and one data line may transmit the data signal and the bias signal in a time-sharing manner. Therefore, one data line may not only transmit the data signal, but also alternately transmit the bias signal. In view of this, the high-frequency transmission of the signal may be implemented, which may facilitate to achieve the high-frequency driving of the display panel.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments illustrated herein but is to be accorded the widest scope consistent with the principles and novel features disclosed herein.

1. A display panel, comprising:
a plurality of pixel circuit columns, wherein a pixel circuit column of the plurality of pixel circuit columns includes a plurality of pixel circuits and is electrically connected with two data lines, and one or both of the two data lines transmits a data signal and a bias signal to a pixel circuit of the plurality of pixel circuits in the pixel circuit column in a time-sharing manner.

2. The display panel according to claim 1, wherein:
adjacent two pixel circuit columns are connected to different data signal terminals through data lines, and a data signal terminal is configured to provide the data signal.

3. The display panel according to claim 1, wherein:
the two data lines connected to the pixel circuit column include a first data line and a second data line, and the data signal and the bias signal belong to different signal types; and
in a same time period, the first data line and the second data line connected to a same one pixel circuit column transmit signals with different types, first data lines connected to adjacent two pixel circuit columns transmit signals with a same type, and second data lines connected to adjacent two pixel circuit columns transmit signals with a same type.

4. The display panel according to claim 1, further including:
a first selection circuit and a second selection circuit, wherein:
the two data lines connected to the same pixel circuit column are connected to the data signal terminal through the first selection circuit, and the two data lines connected to the same pixel circuit column are connected to a bias signal terminal through the second selection circuit, and
the first selection circuit is configured to transmit the data signal provided by the data signal terminal to the data line in a time-sharing manner, and the second selection circuit is configured to transmit the bias signal provided by the bias signal terminal to the data line in a time-sharing manner.

5. The display panel according to claim 4, wherein:
the two data lines connected to the pixel circuit column include a first data line and a second data line,
the first selection circuit includes a first switch and a second switch, both a first terminal of the first switch and a first terminal of the second switch are connected to the data signal terminal, a second terminal of the first switch is connected to the first data line, and a second terminal of the second switch is connected to the second data line,
the second selection circuit includes a third switch and a fourth switch, both a first terminal of the third switch and a first terminal of the fourth switch are connected to the bias signal terminal, a second terminal of the third switch is connected to the first data line, and a second terminal of the fourth switch is connected to the second data line,
the first switch and the fourth switch are simultaneously turned on or off under the control of a first control signal line, and the second switch and the third switch are simultaneously turned on or off under the control of a second control signal line, and
the first switch and the second switch are sequentially turned on or off under the control of the first control signal line and the second control signal line, respectively.

6. The display panel according to claim 5, wherein:
pixel circuits in odd-numbered rows of the pixel circuit column are connected to the first data line, and pixel circuits in even-numbered rows of the pixel circuit column are connected to the second data line.

7. The display panel according to claim 6, wherein:
the pixel circuit includes a driving module, a data-writing module, and a bias module, wherein the data-writing module is configured to transmit the data signal to the driving module, and the bias module is configured to transmit the bias signal to the driving module, and
both the data-writing module and the bias module of the pixel circuit in the odd-numbered row in the pixel circuit column are connected to the first data line, and both the data-writing module and the bias module of the pixel circuit in the even-numbered row in the pixel circuit column are connected to the second data line.

8. The display panel according to claim 7, wherein:
during a time period of displaying one frame, a working process of the pixel circuit includes a data-writing stage, and the data-writing stage includes a data-writing sub-stage and a first bias sub-stage,
in the data-writing sub-stage, the driving module of the pixel circuit is written with the data signal, and in the first bias sub-stage, the driving module of the pixel circuit is written with the bias signal, and
in the data-writing sub-stage, control signals on the first control signal line and the second control signal line are sequentially in a turned-on level, wherein:
the first bias sub-stage occurs after the data-writing sub-stage, and the first bias sub-stage of the pixel circuit in the i^{th} row and the data-writing sub-stage of the pixel circuit in the (i+1)^{th} row at least partially overlap in time, or
the first bias sub-stage occurs before the data-writing sub-stage, and the data-writing sub-stage of the pixel circuit in the j^{th} row and the first bias sub-stage of the pixel circuit in the (j+1)^{th} row at least partially overlap in time, wherein both i and j are integer greater than zero.

9. The display panel according to claim 6, wherein:
the pixel circuit includes a driving module and a data-writing module, wherein the data-writing module is configured to transmit the data signal and the bias signal to the driving module in a time-sharing manner; and
the data-writing module of the pixel circuit in the odd-numbered row in the pixel circuit column is connected to the first data line, and the data-writing module of the pixel circuit in the even-numbered row in the pixel circuit column is connected to the second data line.

10. The display panel according to claim 9, wherein:
during a time period of displaying one frame, a working process of the pixel circuit includes a data-writing stage, and the data-writing stage includes a data-writing sub-stage and a first bias sub-stage,
in the data-writing sub-stage, the driving module of the pixel circuit is written with the data signal, and in the first bias sub-stage, the driving module of the pixel circuit is written with the bias signal, and
in the data-writing sub-stage, control signals on the first control signal line and the second control signal line are sequentially in a turned-on level, wherein:
the first bias sub-stage occurs after the data-writing sub-stage, and the first bias sub-stage of the pixel circuit in the k^{th} row and the data-writing sub-stage of the pixel circuit in the (k+1)^{th} row at least partially overlap in time, wherein k is an integer greater than zero.

11. The display panel according to claim 5, wherein:
the two data lines electrically connected to the pixel circuit column include a first data line and a second data line, and
each pixel circuit in the pixel circuit column is electrically connected with the first data line and the second data line.

12. The display panel according to claim 11, wherein:
the pixel circuit includes a driving module, a data-writing module, and a bias module, wherein the data-writing module is configured to transmit the data signal to the driving module, and the bias module is configured to transmit the bias signal to the driving module,
the data-writing module of the pixel circuit in the odd-numbered row in the pixel circuit column is connected to the first data line, and the bias module of the pixel circuit in the odd-numbered row in the pixel circuit column is connected to the second data line, and
the data-writing module of the pixel circuit in the even-numbered row in the pixel circuit column is connected to the second data line, and the bias module of the pixel circuit in the even-numbered row in the pixel circuit column is connected to the first data line.

13. The display panel according to claim 12, wherein:
during a time period of displaying one frame, a working process of the pixel circuit includes a data-writing stage, and the data-writing stage includes a data-writing sub-stage and a first bias sub-stage,
in the data-writing sub-stage, the driving module of the pixel circuit is written with the data signal, and in the first bias sub-stage, the driving module of the pixel circuit is written with the bias signal, and
in the data-writing sub-stage, control signals on the first control signal line and the second control signal line are sequentially in a turned-on level, wherein:
the first bias sub-stage occurs after the data-writing sub-stage, and the first bias sub-stage of the pixel circuit in the m^{th} row and the data-writing sub-stage of the pixel circuit in the (m+2)^{th} row at least partially overlap in time, or
the first bias sub-stage occurs before the data-writing sub-stage, and the data-writing sub-stage of the pixel circuit in the n^{th} row and the first bias sub-stage of the pixel circuit in the (n+2)^{th} row at least partially overlap in time, wherein both m and n are integer greater than zero.

14. The display panel according to claim 1, wherein:
the two data lines electrically connected to the pixel circuit column include a first data line and a second data line,
pixel circuits in odd-numbered rows of the pixel circuit column are connected to the first data line, and pixel circuits in even-numbered rows of the pixel circuit column are connected to the second data line, and
the first data line and the second data line are connected to different data signal terminals, and a data signal terminal is configured to provide the data signal and the bias signal in a time-sharing manner.

15. The display panel according to claim 14, wherein:
the pixel circuit includes a driving module, a data-writing module, and a bias module, wherein the data-writing module is configured to transmit the data signal to the driving module, and the bias module is configured to transmit the bias signal to the driving module, and
both the data-writing module and the bias module of the pixel circuit in the odd-numbered row in the pixel circuit column are connected to the first data line, and both the data-writing module and the bias module of the pixel circuit in the even-numbered row in the pixel circuit column are connected to the second data line.

16. The display panel according to claim 15, wherein:
during a time period of displaying one frame, a working process of the pixel circuit includes a data-writing stage, and the data-writing stage includes a data-writing sub-stage and a first bias sub-stage,
in the data-writing sub-stage, the driving module of the pixel circuit is written with the data signal, and in the first bias sub-stage, the driving module of the pixel circuit is written with the bias signal, wherein:
the first bias sub-stage occurs after the data-writing sub-stage, and the first bias sub-stage of the pixel circuit in the i^{th} row and the data-writing sub-stage of the pixel circuit in the (i+1)^{th} row at least partially overlap in time, or
the first bias sub-stage occurs before the data-writing sub-stage, and the data-writing sub-stage of the pixel circuit in the j^{th} row and the first bias sub-stage of the pixel circuit in the (j+1)^{th} row at least partially overlap in time, wherein both i and j are integer greater than zero.

17. The display panel according to claim 14, wherein:
the pixel circuit includes a driving module and a data-writing module, wherein the data-writing module is configured to transmit the data signal and the bias signal to the driving module in a time-sharing manner; and
the data-writing module of the pixel circuit in the odd-numbered row in the pixel circuit column is connected to the first data line, and the data-writing module of the pixel circuit in the even-numbered row in the pixel circuit column is connected to the second data line.

18. The display panel according to claim 17, wherein:
during a time period of displaying one frame, a working process of the pixel circuit includes a data-writing stage, and the data-writing stage includes a data-writing sub-stage and a first bias sub-stage, and
in the data-writing sub-stage, the driving module of the pixel circuit is written with the data signal, and in the first bias sub-stage, the driving module of the pixel circuit is written with the bias signal, wherein:
the first bias sub-stage occurs after the data-writing sub-stage, and the first bias sub-stage of the pixel circuit in the k^{th} row and the data-writing sub-stage of the pixel circuit in the (k+1)^{th} row at least partially overlap in time, wherein k is an integer greater than zero.

19. The display panel according to claim 1, wherein:
a working process of the pixel circuit further includes a holding stage, wherein the holding stage includes at least one second bias sub-stage, during a second bias sub-stage of the at least one second bias sub-stage, the driving module of the pixel circuit is written with the bias signal, and a data signal terminal connected to the data line is in a floating state or is configured to provide the bias signal.

20. A display device, comprising:
a display panel, the display panel including:
a plurality of pixel circuit columns, wherein a pixel circuit column of the plurality of pixel circuit columns includes a plurality of pixel circuits and is electrically connected with two data lines, and one or both of the two data lines transmits a data signal and a bias signal to a pixel circuit of the plurality of pixel circuits in the pixel circuit column in a time-sharing manner.
